(19) United States
(12) Patent Application Publication
(10) Pub. No.: US 2009/0313126 A1
(43) Pub. Date: Dec. 17, 2009

(54) LAYERABLE AUCTION MECHANISMS

(75) Inventors: Kamal Jain, Bellevue, WA (US); David John Abraham, Pittsburgh, PA (US); Arash Asadpour Rahimabadi, Stanford, CA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/140,286

(22) Filed: Jun. 17, 2008

(51) Int. Cl. G06Q 30/00

(52) U.S. Cl. 705/14.71; 705/26

(57) ABSTRACT

Described herein is a method for executing a positional auction. The method includes acts of receiving a keyword and executing at least one multi-item single unit demand auction and at least one single-item auction, wherein a plurality of bidders submit bids in the at least one multi-item single unit demand auction and the at least one single-item auction. The method further includes an act of ranking the plurality of bidders based at least in part upon bids submitted in the at least one multi-item single-unit demand auction and the at least one single-item auction. The method additionally includes an act of allocating a subset of the plurality of bidders to particular positions on a search results page based at least in part upon the ranking.

### BACKGROUND

A large portion of revenue from web search engines is derived from advertisers purchasing advertising space adjacent to search result listings. More specifically, web search engines use keyword auctions to sell advertising space alongside search results listings. For instance, a graphical user interface corresponding to a search engine can include a query field that is configured to receive a query from a user. The query will include a keyword (which may be an individual word or a collection of words), and advertisers can bid on the keyword to purchase advertising space thereon.

Pursuant to an example, a user may proffer a keyword “camera” to the search engine. Various camera manufacturers may desire to display an advertisement adjacent to search results for the query, as it may be inferred that the user has an interest in a topic related to a camera, and therefore may have an interest in purchasing a camera. An added complication is that numerous advertisers may wish to purchase advertising space, and may wish to purchase particular positions adjacent to a search results listing. For instance, studies have indicated that advertisements shown in different positions correspond to different attention probabilities (e.g., a probability that a searcher will click on an advertisement or provide some sort of attention to the advertisement).

Auctioning different positions for a common keyword has proven to be problematic, as a single auction has conventionally been held for non-identical items (e.g., positions based upon a common keyword). Furthermore, small changes in an auction mechanism can lead to very large changes in bidding behavior of advertisers and revenue collected by a search engine—accordingly, addressing problems corresponding to auctioning positions for advertisements corresponding to a search results page is difficult.

### SUMMARY

The following is a brief summary of subject matter that is described in greater detail herein. This summary is not intended to be limiting as to the scope of the claims.

Described herein are various technologies pertaining to positional auctions. More particularly, a positional auction can be decomposed into a plurality of multi-item single unit demand auctions, and positions on a search page can be allocated to bidders based upon the multi-item single unit demand auctions. Pursuant to an example, a search query can be received that includes at least one keyword. A plurality of bidders may desirably bid for a position on a search results page that corresponds to the received search query, such that an advertisement pertaining to the search query can be presented to a user. A bidder may desire that an advertisement corresponding to the bidder be presented at a certain position, however.

Accordingly, the positional auction can be decomposed into a plurality of multi-item single unit demand auctions and at least one single-item auction. Winners of the multi-item single unit demand auction can dictate which bidder is allocated which position. Various auction mechanisms can be used in connection with executing the multi-item single unit demand auctions.

Positions can be allocated to bidders based at least in part upon bids submitted by the bidders in the multi-item single unit demand auctions. In another example, positions can be allocated to bidders based at least in part upon click-through rates that correspond to the bidders, and/or weights assigned to the bidders (wherein the weights are independent of bids submitted by the bidders).

Other aspects will be appreciated upon reading and understanding the attached figures and description.

### BRIEF DESCRIPTION OF THE DRAWINGS

FIG. 1 is a functional block diagram of an example system that facilitates executing a positional auction.

FIG. 2 is a functional block diagram of an example system that facilitates locating bidders based at least in part upon a received search query.

FIG. 3 is a functional block diagram of an example system that facilitates generating a search results page that includes advertisements at particular positions.

FIG. 4 is an example graphical user interface.

FIG. 5 illustrates example positions available at a positional auction and corresponding values.

FIGS. 6-9 illustrate example multi-item single unit demand auctions.

FIG. 10 illustrates an example single-item auction.

FIG. 11 is a flow diagram that illustrates an example methodology for allocating a plurality of bidders to a plurality of positions on a search results page.

FIG. 12 is a flow diagram that illustrates an example methodology for displaying advertisements on a search results page.

FIG. 13 is a flow diagram that illustrates an example methodology for ranking bidders.

FIG. 14 is an example computing system.

### DETAILED DESCRIPTION

Various technologies pertaining to position auctions in general, and layerable mechanisms in connection with position auctions in particular, will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

The system 100 includes a receiver component 102 that can receive a search query. An auction component 104 can initiate a positional auction based at least in part upon the search query, wherein the positional auction includes a plurality of multi-item single unit demand auctions. A positional auction may be an auction in which a keyword presented to bidders corresponds to multiple positions on a search results page, where different positions have different values. For example, studies have indicated that particular positions are more frequently viewed and selected by users when compared to other positions. An example of a value that can be assigned to a position is a probability of attention, which is indicative of a probability that a user will review an advertisement when such advertisement is placed at a particular position.

In the example system 100, a search query that includes one or more keywords may have been received by the receiver component 102, thus initiating an auction for a plurality of positions 106-108 on a search results page corresponding to the one or more keywords. As used herein, a keyword can be one or more words, characters, acronyms, etc. that may be provided to a search engine. The auction component 104 can be configured to execute the auction by receiving bids from a plurality of bidders 110-112 for the plurality of multi-item single unit demand auctions. In more detail, the auction component 104 can decompose the positional auction into a plurality of multi-item single-unit demand (MISUD) auctions, and can execute such auctions. A MISUD auction is an auction in which several substantially identical items are auctioned at once. Furthermore, the auction component 104 can decompose the positional auction into a plurality of MISUD auctions and one single-item auction. The auction component 104 may use any suitable auctioning mechanism when executing a MISUD auction or single-item auction, including but not limited to the Generalized Second Price mechanism, the laddered auction, and the Vickrey-Clarke-Groves (VCG) mechanism.

More specifically, k positions may be available in a positional auction, and each of the k positions may have a particular value (e.g., a probability of attention). The auction component 104 can decompose such auction into k MISUD auctions, wherein a first MISUD auction is an auction for k positions, the second auction is an auction for k−1 positions, etc. These different auctions make up a layerable mechanism, which includes multiple j-layer mechanisms. Layerable mechanisms and j-layer mechanisms are described in detail herein.

In greater detail, a keyword auction may include the n bidders 110-112 competing to win one of the k advertising slots (positions) 106-108. Each bidder i may have a value v_{i,j} for winning each slot j. A value may be a value that is personal to a bidder (e.g., the bidder believes that obtaining a certain position has a particular value) or a value that is based upon some sort of metric that is common amongst bidders, such as a probability of attention. If the value is individually assigned by each bidder, then it can be assumed that each bidder values slot j at least as highly as slot j+1. Furthermore, for sake of convenience, it can be assumed that v_{i,k+1}=0.

In a (direct revelation) mechanism (which may be supported by the auction component 104), each bidder 110-112i can submit a private bid b_{i,j} for each slot j. In some instances, a bid b_{i,j} may not equal v_{i,j}. Using such bids, the auction component 104 can use an auctioning mechanism that facilitates allocation of bidders to positions, and can charge each bidder i a price pᵢ. An auctioning mechanism may be characterized by allocation and pricing functions thereof.

Given a fixed collection of bids, x_{i,j} can be a probability that a bidder i has been allocated a position j. If utilities are assumed to be quasilinear, utility of bidder i can be uᵢ=Σⱼ₌₁^{k}x_{i,j}v_{i,j}−pᵢ. Bidders typically select bid amounts to substantially maximize their own utility. In a deterministic allocation, each bidder is assigned to at most one position, no position is assigned to more than one bidder, and if slot j+1 is filled, then slot j is filled. A randomized allocation can be a probability distribution over deterministic allocations. Randomized allocations can be characterized by the following constraints:

1. Σⱼ₌₁^{k}x_{i,j}≦1, for all bidders i;

2. Σᵢ₌₁ⁿx_{i,j}≦1p, for all positions j;

3. Σᵢ₌₁ⁿx_{i,j+1}>0 implies Σᵢ₌₁ⁿx_{i,j}=1, for all positions j.

It is desirable that the auction component 104 perform auctions with various desirable properties, including truthfulness, individual rationality, efficiency, and substantially optimized revenue. Truthfulness relates to each bidder i substantially maximizing utility by bidding truthfully independently of what other bidders bid (e.g., <b_{i,j}=v_{i,j}>ⱼ₌₁^{k}. Individual rationality relates to each bidder i that bids truthfully obtaining utility uᵢ≧0. Efficiency relates to the auction component substantially maximizing social welfare (e.g., Σᵢ₌₁ⁿΣⱼ₌₁^{k}x_{i,j}v_{i,j}). Substantially optimized revenue relates to the auction component 112 substantially maximizing revenue (e.g., Σᵢ₌₁ⁿpᵢ).

The system 100 may utilize particular restrictions of conventional keyword auctions when undertaking an auction setting (a positional auction). More particularly, when positions are identical (e.g., v_{i,j}=v_{i,j+1} for all i and j), the auction setting reduces to a MISUD auction. Furthermore, when there is a single position in the auction setting, the auction setting reduces to a single-item auction. Truthful mechanisms are well-characterized in a single-parameter setting. For instance, vᵢ (e.g., bᵢ) can be a value for bidder i for an item. For any fixed choice b₋ᵢ of bids by other bidders, if bidder i bids bᵢ, then xᵢ(bᵢ) can be a probability that bidder i has of winning an item, and pᵢ(bᵢ) can be a price charged to bidder i.
Theorem 1: A mechanism (x,p) in a single-parameter setting is truthful if and only if, for any bidder i and any fixed choice of b₋ᵢ, 1) xᵢ(bᵢ) is monotone increasing in bᵢ; and 2) pᵢ(bᵢ)=bᵢxᵢ(bᵢ)−∫₀^{b}^{ᵢ}xᵢ(b)db.

The auction component 104 can use the concept of layerable mechanisms in connection with decomposing a positional auction into a plurality of MISUD auctions. Two observations relate to layerable mechanisms. The first observation is an algebraic equivalence: bidder i's value for position j can be written as the telescoping sum v_{i,j}=Σ_{j′=j}^{k}(v_{i,j}, −v_{i,j+1}), since v_{i,k+1}=0. It can be ascertained that each term of the sum represents the difference between bidder i's valuation for two successive positions. Additionally, the aforementioned difference is non-negative, since v_{i,j′}≧v_{i,j′+1}. The second observation is also an equivalence. For instance, a deterministic allocation of bidders to slots can be undertaken, in which, without loss of generality, bidder i wins position i, for i=1 to k. By rewriting each bidder i's allocated value v_{i,i}, the following can be obtained:

TABLE 1

| | Telescoping Sum Layer | | | | |
|---|---|---|---|---|---|
| Value | 1 | 2 | 3 | . . . | k |
| v_{1,1} | v_{1,1} − v_{1,2} | v_{1,2} − v_{1,3} | v_{1,3} − v_{1,4} | . . . | v_{1,k} − v_{1,k+1} |
| v_{2,2} | | v_{2,2} − v_{2,3} | v_{2,3} − v_{2,4} | . . . | v_{2,k} − v_{2,k+1} |
| v_{3,3} | | | v_{3,3} − v_{3,4} | . . . | v_{3,k} − v_{3,k+1} |
| . | . | . | . | . | . |
| . | . | . | . | . | . |
| . | . | . | . | . | . |
| v_{k,k} | | | | . . . | v_{k,k} − v_{k,k+1} |

To determine an allocation value, each row can be summed (e.g., telescoping sum) and row-sums can be added. Additionally or alternatively, each layer (e.g., column) can be summed and the layer-sums can be added. It can be noted that when the layers are summed, in the jth layer, j bidders “win” the difference between their valuations for position j and position j+1. It can also be noted that if a bidder wins in layer j, the bidder also wins in layer j+1.

Accordingly, a layer-j mechanism Mⱼ can be defined as a layer in which bidders compete to win one of j identical tokens, where each of the tokens have a value v_{i,j}−v_{i,j+1} to bidder i. Thus, Mⱼ is a MISUD auction in which bidders have single-parameter valuations.

Pursuant to an example, d_{i,j} can be a bid of bidder i in Mⱼ, where d_{i,j} may or may not equal v_{i,j}−v_{i,j+1}. Furthermore, given a fixed collection of bids, y_{i,j} can be the probability that bidder i is allocated a token in Mⱼ. Since there are j tokens to sell, Σᵢ₌₁ⁿy_{i,j}≦j. Moreover, p_{i,j} can be the price charged to bidder i by Mⱼ. Finally, u_{i,j}=y_{i,j}(v_{i,j}−v_{i,j+1})−p_{i,j} can be the utility of bidder i. Given the above, a class of layerable mechanisms can be defined.
Definition 1: A keyword auction mechanism M is layerable under valuation class V if and only if there exist mechanisms (M₁, M₂, . . . , Mₖ), such that each Mⱼ is a layer-j mechanism, and, for all bids <b_{i,j}>_{i=1,j=1}^{i=n,j=k} from V, if d_{i,j}=b_{i,j}−b_{i,j+1}, then for all bidders i:

1. Σⱼ₌₁^{k}x_{i,j}v_{i,j}=Σⱼ₌₁^{k}y_{i,j}(v_{i,j}−v_{i,j+1}), and

2. pᵢ=Σⱼ₌₁^{k}p_{i,j}.

As used herein, M=(M₁, M₂, . . . , Mₖ). Also, if Mⱼ=M for all j, M is self-layerable.

Arbitrarily combing j-layer mechanisms, however, may not be feasible. The following theorem facilitates collection of j-layer mechanisms to form a layerable mechanism.
Theorem 2: Given mechanisms (M₁, M₂, . . . , Mₖ) for each layer, there exists a layerable mechanism M=(M₁, M₂, . . . , Mₖ) under valuation class V, if, for all bids <b_{i,j}>_{i=1,j=1}^{i=n,j=k} from V, y_{i,j}≦y_{i,j+1} when d_{i,j}=b_{i,j}−b_{i,j+1}.

In support of the above theorem, it can be noted that if M exists, a price function of M can be set to pᵢ=Σⱼ₌₁^{k}p_{i,j}. It remains to be illustrated, however, that a feasible allocation function x_{i,j} exists such that all bidders 110-112 are allocated a substantially similar value under x_{i,j} as the bidders 110-112 obtain in (M₁, M₂, . . . , Mₖ). For purposes of explanation, bidder i can be considered:

$$\begin{matrix}{\sum }_{j = 1}^{k} {y}_{i , j} ( {v}_{i , j} - {v}_{i , j + 1} ) = {\sum }_{j = 1}^{k} {y}_{i , j} {v}_{i , j} - {\sum }_{j = 1}^{k} {y}_{i , j} {v}_{i , j + 1} \\ = {\sum }_{j = 1}^{k} {y}_{i , j} {v}_{i , j} - {\sum }_{j = 2}^{k + 1} {y}_{i , j - 1} {v}_{i , j} \\ = {\sum }_{j = 1}^{k} {v}_{i , j} ( {y}_{i , j} - {y}_{i , j - 1} )\end{matrix}$$

where y_{i,0}=v_{i,k+1}=0. By setting x_{i,j}=(y_{i,j}−y_{i,j-1}), bidder i obtains the same value from x as from (M₁, M₂, . . . , Mₖ). It can also be noted that x_{i,j}≧0, since y_{i,j-1}≦y_{i,j}. It can also be noted that Σⱼ₌₁^{k}x_{i,j}=y_{i,k}≦1, so no bidder is overpacked.

It is possible, however, that a particular position is overpacked—e.g., Σᵢ₌₁ⁿx_{i,j}=1+s for some surplus s>0. In such a case, the auction component 104 can repack the allocation. It can also be noted that the total allocation to the first j positions is Σᵢ₌₁ⁿΣ_{j′=1}^{j}x_{i,j′}=Σᵢ₌₁ⁿΣ_{j′=1}^{j}(y_{i,j}−y_{i,j′-1}=Σᵢ₌₁ⁿy_{i,j}≦j), where a last inequality follows from the feasibility of y. Since Σᵢ₌₁ⁿx_{i,j}=1+s, the total allocation to the first (j−1) positions can be Σᵢ₌₁ⁿΣ_{j′=1}^{j-1}x_{i,j}≦j−1−s. Hence, at least the surplus s can be used to repack position j allocations into earlier slots. Finally, since v_{i,j-1}≧v_{i,j} for all j, the surplus can be used while not overpacking any bidder or changing an allocated value of any bidder.

The auction component 104 can further select a universal ranking of the bidders 110-112, and have each layer-j mechanism allocate tokens to the first j-bidders in the ranking. Thus, the auction component 104 can utilize a rank-based allocation function, which can select a ranking of bidders and allocate the j-th bidder in the ranking to position j. Such allocation is substantially similar to an allocation obtained by running a rank-based mechanism on each layer, since the j-th bidder wins tokens in layers k to j, and thus obtains value if Σ_{j′=j}^{k}(v_{j,j′}−v_{j,j′+1})=v_{j,j}.

Examples of rank-based mechanisms that can be used by the auction component 112 include a generalized first price auction (GFP), a generalized second price auction (GSP), a laddered auction, amongst others. These mechanisms can be defined as follows: each bidder i has a value vᵢ per user click-through if an advertisement corresponding to the bidder. Bidder i's value for slot j can be v_{i,j}=CTR_{i,j}vᵢ, where CTR_{i,j} is the click-through rate of i's advertisement in positions. It can be ascertained that CTR_{i,j}≧CTR_{i,j+1}, since v_{i,j}≧v_{i,j+1}. Furthermore, the auction component 104 can assign each bidder a weight wᵢ, where the weight wᵢ is independent of the bid of bidder i. GFP, GSP, and laddered auction mechanisms rank bidders in non-decreasing order of wᵢvᵢ. It can be verified that such mechanisms are self-layerable, since the sum of prices in each layer is the price charged by the overall mechanism.

Additionally or alternatively, the auction component 104 can use an efficient allocation function in each layer with a restricted class of valuations. For instance, click-through rates may be separated into a bidder-specific and position-specific factor, such that CTR_{i,j}=uᵢθⱼ. Thus, if bidder i has a higher uᵢvᵢ product than bidder i′, v_{i,j}≧v_{i′,j} for all j. Furthermore, (v_{i,j}−v_{i,j+1})=uᵢvᵢ(θⱼ−θⱼ₊₁)≧uᵢ,v_{i′}(θⱼ−θⱼ₊₁)=(v_{i′,j}−v_{i′,j+1}). Accordingly, an efficient allocation in layer-j awards tokens to bidders with the j largest uᵢvᵢ products, and any bidder that wins a token in layer-j also wins a token in layer-j+1. This is substantially similar to a rank-based allocation mechanism in which

$$\frac{{u}_{i}}{{w}_{i}} = \frac{{u}_{{i}^{′}}}{{w}_{{i}^{′}}} .$$

It can also be verified that the VCG mechanism is self-layerable in such a restricted setting. Further, the setting can be generalized such that if (v_{i,j}−v_{i,j+1})>(v_{i′,j}−v_{i′,j+1}), then (v_{i,j′}−v_{i,j′+1})>(v_{i′,j′}−v_{i′,j′+1}) for all j′. It can thus be seen from the above that the auction component 104 can receive click-through rates corresponding to bidders and allocate bidders to positions based at least in part upon the click-through rates corresponding to the bidders.

In addition, layerable mechanisms can inherit properties of j-layer mechanisms therein. Thus, desirably properties can be built into each layer.
Theorem 3: M=(M₁, M₂, . . . , Mₖ) can be a layerable mechanism under valuation class V. Then,

1. M is individually rational if Mⱼ is individually rational, for all j.

2. M is truthful if and only if Mⱼ is truthful, for all j.

The first statement is immediate, and the second statement can be proved as shown below. It can be assumed that M is not truthful—then for some fixed choice of bids by other bidders, some bidder has a strategic bid such that uᵢ(<b_{i,j}>ⱼ₌₁^{k})>uᵢ(<_{i,j}>ⱼ₌₁^{k}). According to definition 1 above, if bidder i bids truthfully in (M₁, M₂, . . . , Mₖ), the bidder obtains utility uᵢ(<v_{i,j}>ⱼ₌₁^{k}). If, however, bidder i bids <d_{i,j}=(b_{i,j}−b_{i,j+1})>ⱼ₌₁^{k}, the bidder obtains utility uᵢ(<b_{i,j}>ⱼ₌₁^{k}). Thus, Mⱼ must not be truthful, which is a contradiction.

It can be assumed that for a contradiction some layer is not truthful. It can be noted that bids <d_{i,j}>_{i=1,j=1}^{i=n,j=k} in (M₁, M₂, . . . , Mₖ) can be assumed to be allowable when there exist <b_{i,j}>_{i=1,j=1}^{i=n,j=k} under V such that d_{i,j}==b_{i,j}−b_{i,j+1}. Furthermore, u_{T} can be bidder i's utility when bidder i bids truthfully in all layers. Then for some fixed collection of bids d₋ᵢ by the other bidders, u_{S}>u_{T}. If bidder i bids truthfully in M, the bidder obtains utility u_{T}. If bidder i bids b_{i,j}=Σ_{j′=j}^{k}d_{i,j′}, the bidder can obtain utility u_{S}>u_{T}, which contradicts truthfulness of M.

In order to build a truthful layerable mechanism that can be used by the auction component 104, truthful layer-j mechanisms can be combined. Theorem 1 above provides one example characterization of truthful layer-j mechanisms. Thus, a monotonic allocation function can be used, and from such allocation function, a pricing function that may be used by the auction component 104 can be ascertained.

For instance, bᵢ can be a value-per-click bid of bidder i in a ranking of bidders (ranked by wᵢvᵢ), such that the bid of bidder i in layer-j is d_{i,j}=(CTR_{i,j}−CTR_{i,j+1})bᵢ. Bidder i≦j wins as long as wᵢbᵢ>wⱼ₊₁bⱼ₊₁. Accordingly, a minimum bid for bidder i to win is d′_{i,j}=(CTR_{i,j}−CTR_{i,j+1})wⱼ₊₁bⱼ₊₁/wᵢ. Substituting such expressions into Theorem 1, p_{i,j}(d_{i,j})=d_{i,j}−(d_{i,j}−d′_{i,j})=(CTR_{i,j}−CTR_{i,j+1})wⱼ₊₁bⱼ₊₁/wᵢ. Since bidder i wins in layers k through i, a total price that can be charged to bidder i by the auction component 112 can be Σⱼ₌₁^{k}(CTR_{i,j}−CTR_{i,j+1})wⱼ₊₁bⱼ₊₁/wᵢ.

In summary, the receiver component 102 can receive a search query that can include one or more keywords. The auction component 104 can execute a positional auction by decomposing the positional auction into k MISUD auctions, wherein a first MISUD auction is an auction for k positions, the second auction is an auction for k−1 positions, etc. The auction component 104 can receive bids from the bidders 110-112 and can award tokens to winners of the MISUD auctions, and the auction component 104 can allocate bidders to positions based upon the MISUD auctions. The auction component 104 can use various layerable mechanisms, which can ensure that the bidders 110-112 are bidding truthfully (e.g., the bidders are bidding according to a value they assign to positions).

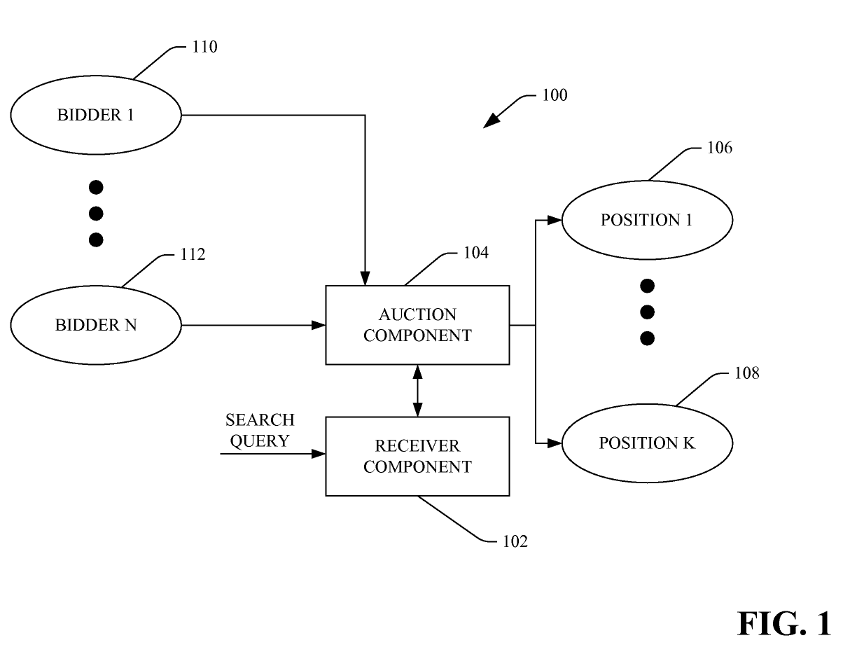

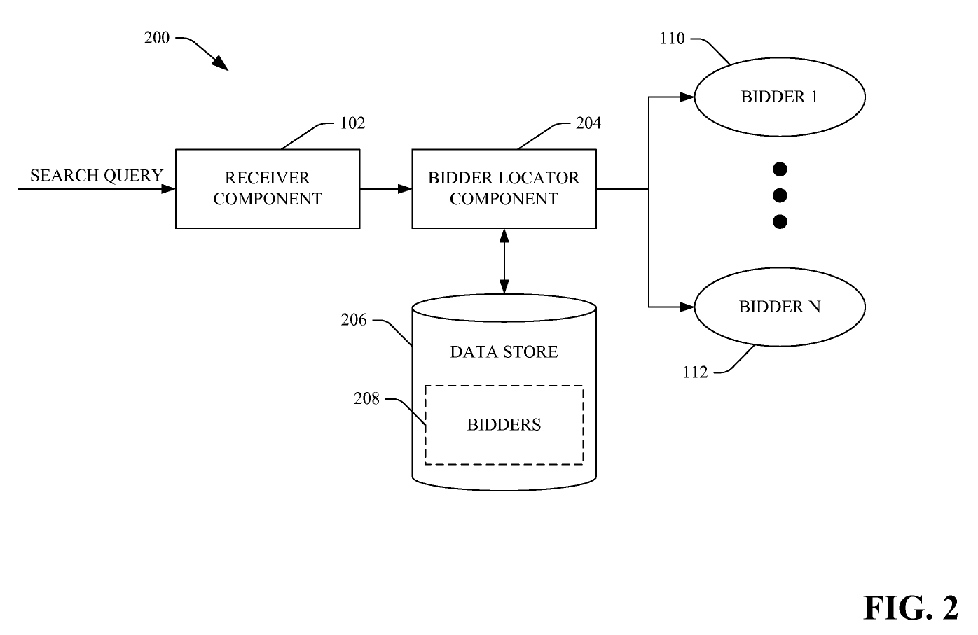

Referring now to FIG. 2, an example system 200 that facilitates determining bidders that desire to bid with respect to a keyword (e.g., to determine bidders for a received keyword) is illustrated. The system 200 includes the receiver component 102 that receives the search query from a user. The search query includes one or more keywords. A bidder locator component 204 can receive and process the query and locate merchants (bidders) that desire to bid on positions on a search page that presents search results pertaining to the keyword. For instance, the bidder locator component 204 can access a data store 206 that includes numerous prospective bidders 208, and can locate bidders that wish to bid on the received keywords. The resulting bidders 110-112 can then bid in the several multi-item single unit demand auctions generated by the auction component 104 (FIG. 1).

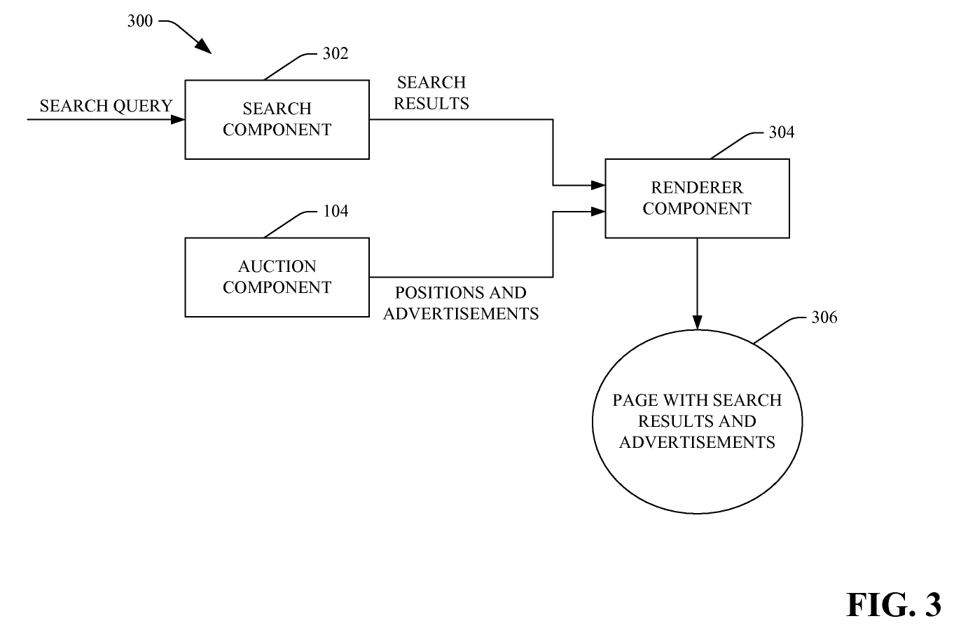

With reference now to FIG. 3, an example system 300 that facilitates provision of a search page to a user that includes a list of search results and advertisements in particular positions is depicted. The system 300 includes a search component 302 that receives a search query. For instance, the search query received by the search component 302 may be substantially similar to the search query received by the receiver component 102 (FIG. 1). The search component 302 can search for documents based at least in part upon the received search query. As used herein, a document may be a web page, an image, a video, a word processing document, a spreadsheet application, an audio item, an XML document, and/or other suitable document.

The system 300 can further include the auction component 104, which can perform a positional auction as described above. More particularly, the auction component 104 can allocate bidders to positions on a search results page. A renderer component 304 can generate a search page 306 that includes search results pertaining to the received search query as well as advertisements that are depicted at positions bid upon by several bidders.

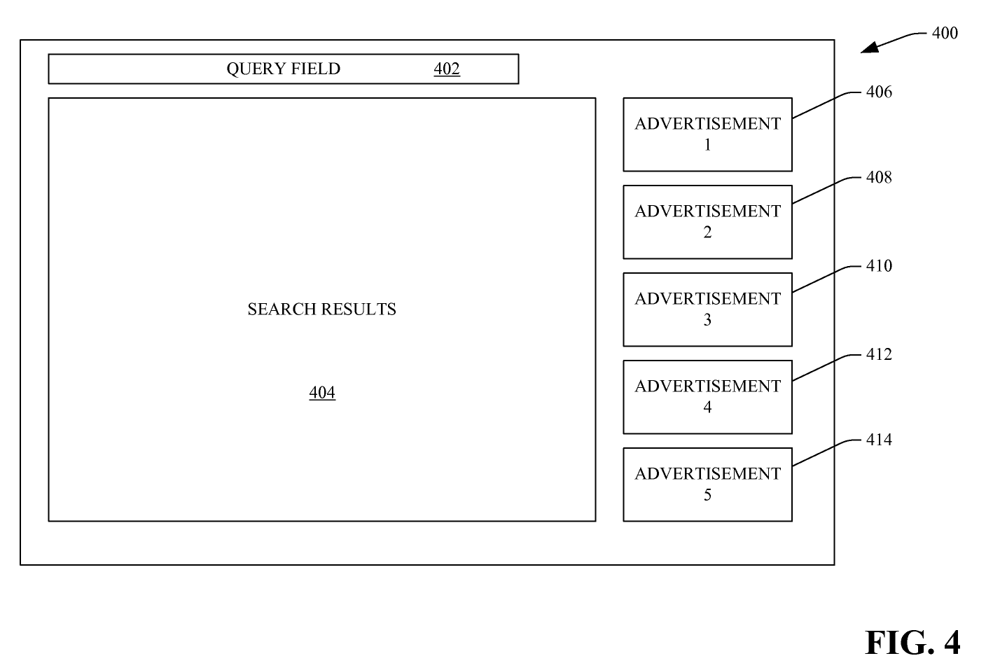

Turning now to FIG. 4, an example graphical user interface 400 that presents advertisements in particular positions based at least in part upon an allocation of bidders to positions undertaken by the auction component 104 (FIG. 1) is illustrated. The graphical user interface 400 includes a query field 402 that is configured to receive search queries from a user. The graphical user interface 400 also includes a search results field 404 that is configured to present a listing of search results to a user. The graphical user interface 400 additionally includes a plurality of advertisements 406-414 that are placed in particular positions in accordance with an allocation of bidders to positions by the auction component 104.

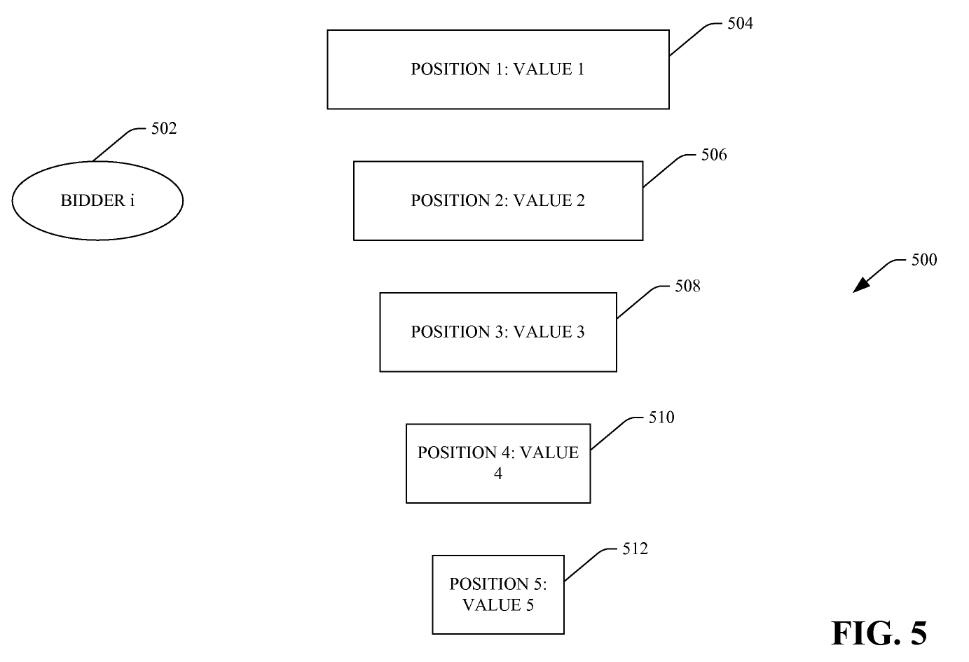

With reference now to FIG. 5, an example depiction 500 of a positional auction as undertaken by the auction component 104 is illustrated. A bidder 502 (bidder i) may desire to advertise to a user given that the user has provided a search engine with a search query (that includes one or more keywords). In this example, five positions 504-512 are available by way of auction, wherein bidders desire that their advertisements be displayed on one of the positions. Bidders can bid in accordance with a value that the bidder assigns to one or more positions.

In this example, the first position 504 has a first value to the bidder 502 that is higher than values to the bidder 502 of the remaining positions 506-512. Further, the second position 506 has a second value to the bidder 502 that is higher than values to the bidder 502 of positions 508-512 but lower than the first value that corresponds to the first position 504. The third position 508 has a third value to the bidder 502 that is higher than values of the fourth and fifth positions 510 and 512, respectively, but lower than values of the first and second positions 504 and 506, respectively. The fourth position 510 has a fourth value to the bidder 502 that is higher than the values of the fifth position 512 to the bidder 502 and lower than the values of the first, second, and third positions 502-508, respectively. Finally, the fifth position 512 has a fifth value to the bidder 502 that is lower than the values to the bidder of the positions 504-510. Additionally or alternatively, the values may be based upon a common metric, such as an attention probability.

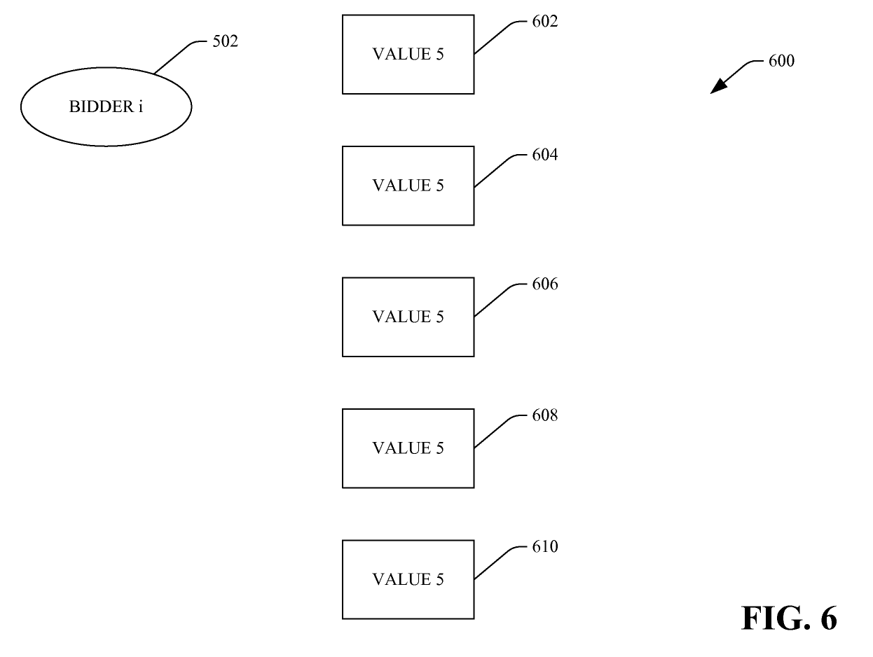

Turning now to FIG. 6, an example illustration 600 that depicts a first MISUD auction (layer) is illustrated. The MISUD auction is an auction for five 602-610 positions that have values corresponding to the fifth value to the bidder 502 of the fifth position 512 (FIG. 5). Multiple bidders can bid in an attempt to win one of the five positions. The auction component 104 (FIG. 1) can allocate a token to five winners of the MISUD auction.

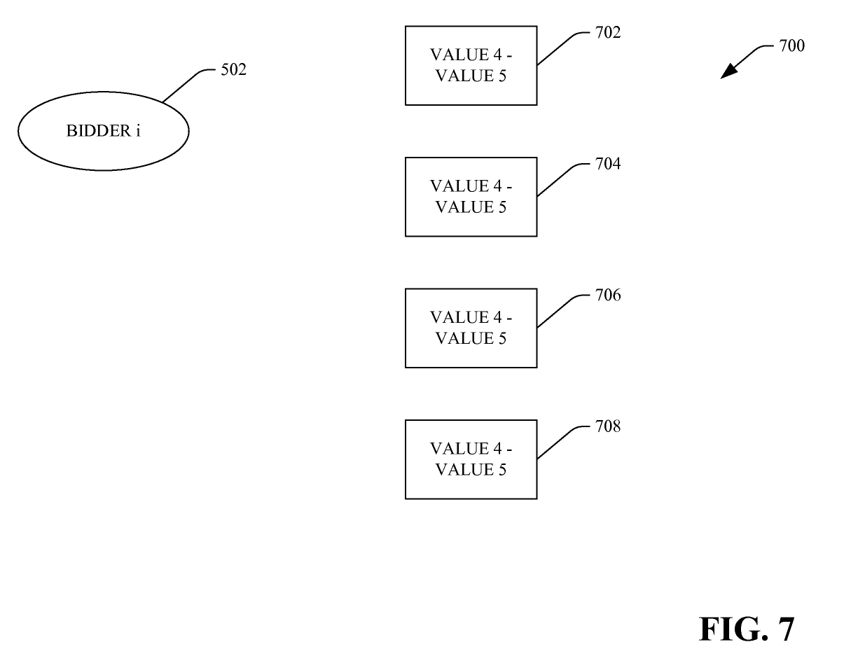

With reference to FIG. 7, an example illustration 700 that depicts a second MISUD auction (layer) is illustrated. The MISUD auction is an auction for four positions 702-708 that have values to the bidder 502 corresponding to the difference between the fourth value and the fifth value noted above. Again, multiple bidders can bid in an attempt to win one of the four positions, and the auction component 104 (FIG. 1) can allocate a token to four winners of such MISUD auction.

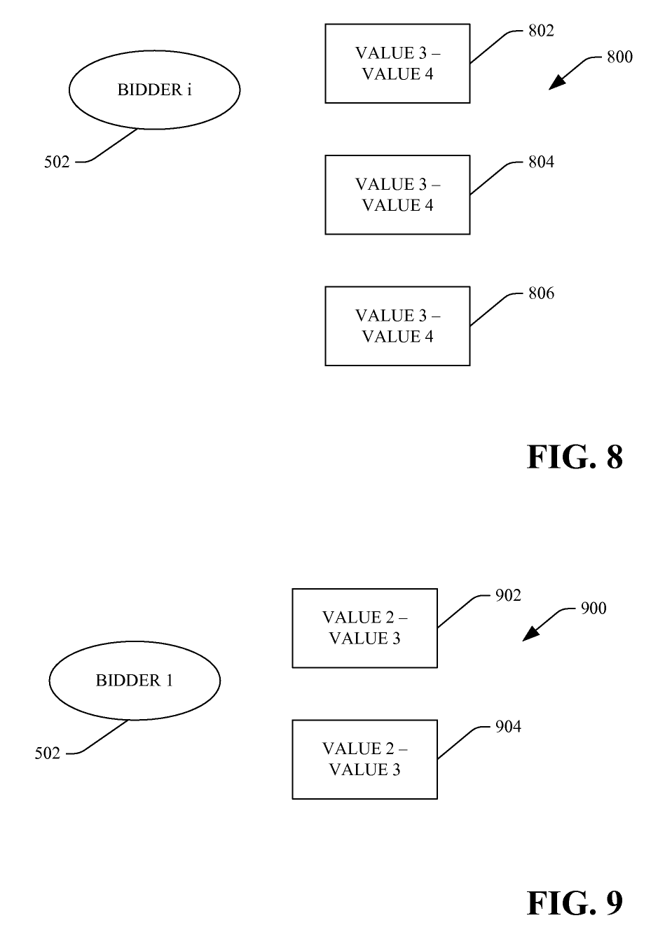

Now referring to FIG. 8, another example illustration 800 that depicts a third MISUD auction (layer) that can be undertaken by the auction component 104 (FIG. 1) in connection with a positional auction is illustrated. The third MISUD auction is an auction for three positions 802-806 that have values to the bidder 502 corresponding to the difference between the third and fourth values described above. The auction component 104 can receive multiple bids for the three positions, and can allocate a token to three winners of the MISUD auction.

Turning now to FIG. 9, yet another example illustration 900 that depicts a fourth MISUD auction (layer) that can be undertaken by the auction component 104 in connection with the positional auction is illustrated. The fourth MISUD auction is an auction for two positions 902-904 that have values to the bidder 502 corresponding to the difference between the second and third values noted above. The auction component 104 can receive multiple bids for the two positions, and can allocate a token to two winners of the MISUD auction.

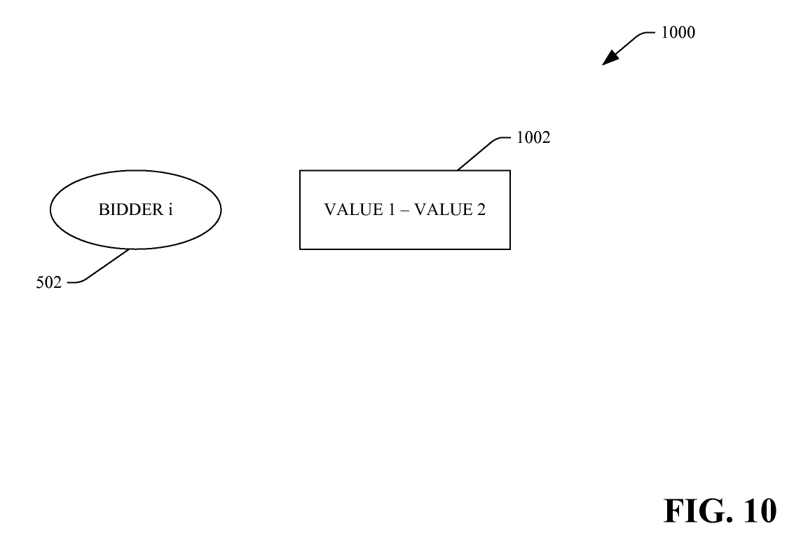

Now referring to FIG. 10, an example illustration 1000 that depicts a single-item auction (a fifth layer), wherein the single-item is a position that has a value corresponding to the difference between the first value and the second value described above with respect to FIG. 5. The auction component 104 can receive multiple bids for the single item, and can allocate a token to the winner. Once the five auctions have been completed, the auction component 104 can allocate bidders to one of the five positions 504-512 (FIG. 5) according to winners of the auctions. The auction component 504-512 can further charge a particular price to the winners, wherein the price is based at least in part upon bids of the winners. If there happens to be a tie for one or more of the positions, the auction component 104 can randomly allocate positions to bidders that have tied for one or more of the positions. In another example, the auction component 104 can use one or more deterministic rules to allocate positions to bidders in the event of a tie (e.g., allocate positions to bidders based upon alphabetical priority).

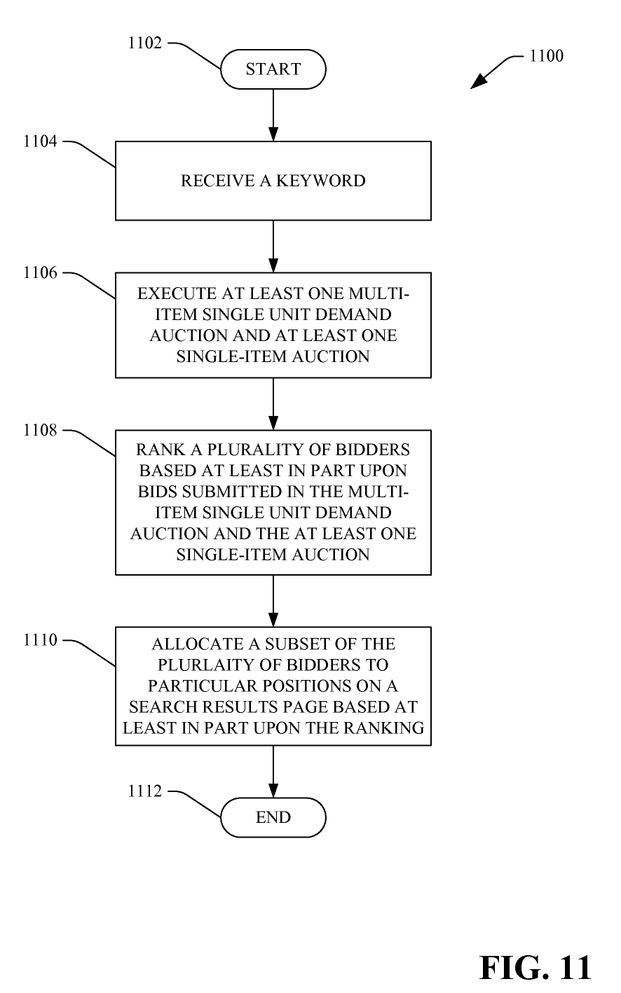

With reference now to FIGS. 11-13, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring specifically to FIG. 11, an example methodology 1100 for executing a positional auction in connection with a search engine is illustrated. The methodology 1100 starts at 1102, and at 1104 a keyword is received. The keyword can be a word, a series of words, an acronym, a number, a series of numbers, etc.

At 1106, at least one multi-item single unit demand auction is executed, and at least one single-item auction is executed. For instance, a plurality of bidders can submit bids in the at least one multi-item single unit demand auction and the at least one single-item auction.

At 1108, the plurality of bidders are ranked based at least in part upon bids submitted in the at least one multi-item single unit demand auction and the at least one single-item auction.

At 1110, a subset of the plurality of bidders can be allocated to particular positions on a search results page based at least in part upon the ranking undertaken at act 1108. The methodology 1100 completes at 1112.

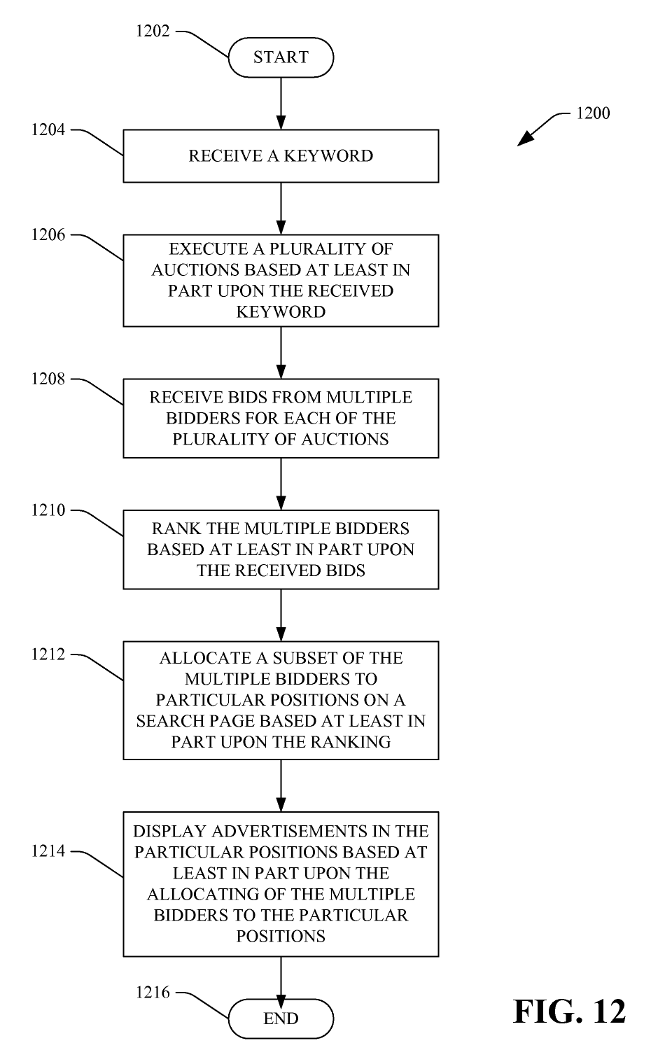

With reference now to FIG. 12, an example methodology 1200 for displaying advertisements in particular positions on a search results page is illustrated. The methodology 1200 starts at 1202, and at 1204 a keyword is received. At 1206, a plurality of auctions are executed based at least in part upon the received keyword. Pursuant to an example, the plurality of auctions can include multiple multi-item single-unit demand auctions and at least one single-item auction. Moreover, a number of the plurality of auctions can correspond to a number of positions available for displaying advertisements, wherein a number of items in a first multi-item single-unit demand auction may be different from a number of items in a second multi-item single-unit demand auction.

At 1208, bids from multiple bidders for each of the plurality of auctions are received. As noted above, the bids can be received for layer-j mechanisms. At 1210, the multiple bidders are ranked based at least in part upon the received bids.

At 1212, a subset of the multiple bidders are allocated to particular positions on a search page based at least in part upon the ranking undertaken at act 1210. At 1214, advertisements are displayed in the particular positions based at least in part upon the allocating of particular positions to the subset of the multiple bidders undertaken at 1212. The methodology 1200 completes at 1216.

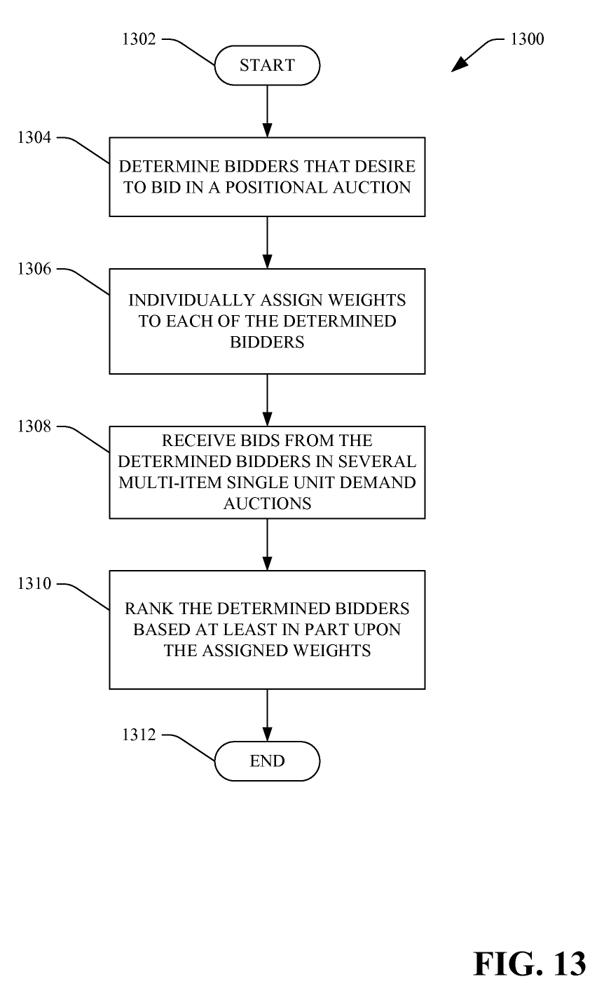

Turning now to FIG. 13, an example methodology 1300 for ranking bidders in a positional auction is illustrated. The methodology 1300 starts at 1302, and at 1304 bidders that desire to bid in a positional auction are determined. For instance, a keyword can be received and bidders that wish to bid on such keyword can be located.

At 1306, weights are individually assigned to each of the determined bidders. Pursuant to an example, the weights can be independent of bids submitted by the bidders. For instance, the weights may be based at least in part upon click-through rates corresponding to the bidder, an amount of revenue expected to be derived from the bidder, etc.

At 1308, bids from the determined bidders are received for multiple multi-item single-unit demand auctions. At 1310, the determined bidders are ranked based at least in part upon the weights assigned thereto. Furthermore, for instance, the determined bidders can be ranked based at least in part upon amounts of bids submitted by the determined bidders. The methodology 1300 then completes at 1312.

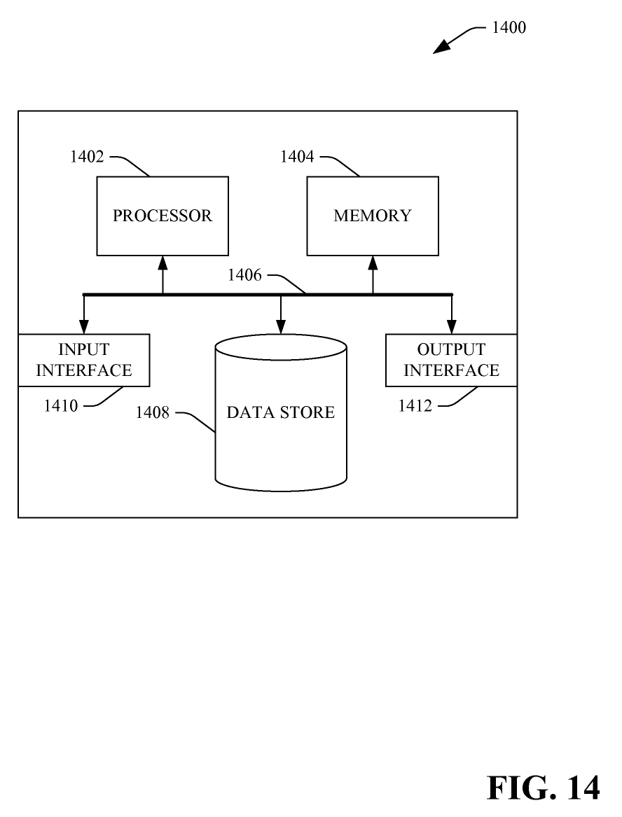

Now referring to FIG. 14, a high-level illustration of an example computing device 1400 that can be used in accordance with the systems and methodologies disclosed herein is illustrated. For instance, the computing device 1400 may be used in a system that can facilitate executing a positional auction. The computing device 1400 includes at least one processor 1402 that executes instructions that are stored in a memory 1404. The instructions may be, for instance, instructions for implementing functionality described as being carried out by one or more components discussed above or instructions for implementing one or more of the methods described above. The processor 1402 may access the memory 1404 by way of a system bus 1406. In addition to storing executable instructions, the memory 1404 may also store weights, bidder identities, bids, click-through rates, etc.

The computing device 1400 additionally includes a data store 1408 that is accessible by the processor 1402 by way of the system bus 1406. The data store 1408 may include executable instructions, advertisements, identities of bidders, weights, etc. The computing device 1400 also includes an input interface 1410 that allows external devices to communicate with the computing device 1400. For instance, the input interface 1410 may be used to receive instructions from an external computer device, a query, a click on an advertisement, etc. The computing device 1400 also includes an output interface 1412 that interfaces the computing device 1400 with one or more external devices. For example, the computing device 1400 may transmit a search results page and advertisements by way of the output interface 1412.

Additionally, while illustrated as a single system, it is to be understood that the computing device 1400 may be a distributed system. Thus, for instance, several devices may be in communication by way of a network connection and may collectively perform tasks described as being performed by the computing device 1400.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system that facilitates executing a positional auction, comprising:
a receiver component that receives a search query; and
an auction component that initiates a positional auction based at least in part upon the query, wherein the positional auction comprises a plurality of multi-item single-unit demand auctions.

2. The system of claim 1, wherein the auction component executes the plurality of multi-item single-unit demand auctions and employs one of a Generalized First Price mechanism, a Generalized Second Price mechanism, a laddered auction, or a Vickrey-Clarke-Groves auction when executing the plurality of multi-item single-unit demand auctions.

3. The system of claim 1, wherein the auction component allocates bidders to advertising positions and charges each winning bidder a price that is based at least in part upon an amount bid by each of the bidders.

4. The system of claim 1, wherein the plurality of multi-item single-unit demand auctions make up a layerable mechanism.

5. The system of claim 1, wherein a number of multi-item single-unit demand auctions in the plurality of multi-item single-unit demand auctions is one less than a number of positions being auctioned in the positional auction.

6. The system of claim 5, wherein the auction component decomposes the positional auction into the plurality of multi-item single-unit demand auctions and a single-item auction.

7. The system of claim 1, wherein bidders in the position auction have single-parameter valuations for each of the plurality of multi-item single-unit demand auctions.

8. The system of claim 1, wherein the auction component allocates tokens to winners of each of the plurality of multi-item single-unit demand auctions and allocates bidders to positions based at least in part upon tokens allocated.

9. The system of claim 1, wherein the auction component receives click-through rates corresponding to bidders and allocates bidders to positions based at least in part upon the click-through rates corresponding to the bidders.

10. The system of claim 1, wherein a price charged to a bidder by the auction component is based at least in part upon a click-through rate corresponding to the bidder.

11. The system of claim 1, further comprising a search component that receives a search query and searches for documents based at least in part upon the received search query, wherein the positional auction is based at least in part upon the received search query.

12. The system of claim 11, further comprising a renderer component that generates a search page that includes search results pertaining to the received search query and advertisements that are depicted at positions bid upon by several bidders.

13. The system of claim 1, wherein the auction component assigns a weight to each bidder in the positional auction, wherein the weight is independent of bids proffered by each bidder.

14. A method for executing a positional auction comprising the following computer-executable acts:
receiving a keyword;
executing at least one multi-item single unit demand auction and at least one single-item auction, wherein a plurality of bidders submit bids in the at least one multi-item single unit demand auction and the at least one single-item auction;
ranking the plurality of bidders based at least in part upon bids submitted in the at least one multi-item single unit demand auction and the at least one single-item auction; and
allocating a subset of the plurality of bidders to particular positions on a search results page based at least in part upon the ranking.

15. The method of claim 14, further comprising:
executing a search based at least in part upon the received keyword;
displaying search results on a graphical user interface; and
displaying advertisements corresponding to the bidders in the positions allocated to the bidders.

16. The method of claim 14, further comprising ranking the plurality of bidders based at least in part upon click-through rates corresponding to the plurality of bidders.

17. The method of claim 14, further comprising using one of a Generalized First Price mechanism, a Generalized Second Price mechanism, a laddered auction, or a Vickrey-Clarke-Groves auction when ranking the plurality of bidders.

18. The method of claim 14, further comprising setting a price to charge the bidders that win the positional auction based at least in part upon the bids submitted by the bidders and click-through rates corresponding to the bidders.

19. The method of claim 14, further comprising:
assigning weights to each bidder in the plurality of bidders, wherein the weights are independent of bids submitted by the plurality of bidders; and
ranking the plurality of bidders based at least in part upon the assigned weights.

20. A computer-readable medium comprising instructions that, when executed by a processor, perform the following acts:
receiving a keyword;
executing a plurality of auctions based at least in part upon the received keyword, wherein the plurality of auctions include several multi-item single-unit demand auctions and at least one single-item auction, wherein a number of the plurality of auctions corresponds to a number of positions available for displaying advertisements, wherein a number of items in a first multi-item single-unit demand auction is different from a number of items in a second multi-item single-unit demand auction;
receiving bids from multiple bidders for each of the plurality of auctions;
ranking the multiple bidders based at least in part upon the received bids;
allocating a subset of the multiple bidders to particular positions on a search page based at least in part upon the ranking; and
displaying advertisements in the particular positions based at least in part upon the allocating of particular positions to the subset of the multiple bidders.
